(19) United States
(12) Patent Application Publication
(10) Pub. No.: US 2012/0130990 A1
(43) Pub. Date: May 24, 2012

(54) Fragrance sampling, and exhibition system

(76) Inventor: John Hissong, Pismo Beach, CA (US)

(21) Appl. No.: 12/927,762

(22) Filed: Nov. 22, 2010

(51) Int. Cl. B65D 77/00; G06F 17/30; B42D 1/00

(52) U.S. Cl. 707/722; 206/216; 281/2; 707/741; 707/E17.002; 707/E17.009; 707/E17.014

(57) ABSTRACT

A Fragrance Sampling, and Exhibition System includes at least one fragrance card, fragrance, and a laminated envelope. The fragrance is disposed upon the fragrance card. The fragrance card is disposed within the laminated envelope.

### CROSS REFERENCE

The present application incorporates by reference a previous pending patent application by the same applicant/inventor entitled “A Fragrance Inventory and Display System for Cataloguing, Storing, Categorizing, Sampling, Exhibiting, and Ordering various Fragrances”.

### FIELD OF THE INVENTION

The present invention is in the area of fragrances such as perfumes and colognes and more particularly pertains to a system for marketing perfumes and fragrances through cards imbued with fragrances.

### BACKGROUND OF THE INVENTION

One of the main issues which inhere with the marketing of fragrances is the difficulty of articulating what a fragrance smells like. Most consumer goods or services can be described through visual imagery, sounds, songs, and the like. Even with food, the aesthetic look of food can give a prospective customer an idea of what that food may taste like.

However, when it comes to fragrances, it is difficult to articulate the aesthetics of a fragrance through imagery, video, sounds etc. through Television or radio. Magazine inserts obviously work well, however, with the downward trend of print advertising, even this marketing conduit has become marginalized.

One of the overarching trends over the past few decades is the gradual push for customization and niche production. This trend has created a strong need for a more variegated supply of options as it relates to fragrances. This heightened demand has created profound opportunities within the fragrance industry.

Of course, being able to market a more granular plurality of options as it concerns fragrances requires more organization, systematic means of tabulating, categorizing, and comparisons between fragrances. Moreover, supporting this plurality of options requires a more targeted marketing system as opposed to the mass-market approach commonly undertaken.

To seize upon this opportunity, some experts in the fragrance industry have created various taxonomic systems, which categorize fragrances by various types of qualities. Some of these qualities can be quantified through various measurements, etc. And through this taxonomy, the fragrance industry has been able to transform itself from an ad hoc hit and miss operation to a more precise industry.

For instance, in the past if a customer enjoyed a particular fragrance, there was no way in which they could find a similar smelling fragrance through any sort of organizational system. If a customer wanted to find a similar fragrance, they would literally have to smell hundreds to thousands of different fragrances in a scattershot approach. However, the new taxonomic fragrance systems have enabled consumers to explore their options by finding similar fragrances according to well-defined and classified metrics based on notes, and other chemical qualities.

As such, what is needed in the market is a system for marketing fragrances in a more systematic and orderly fashion. Such a system should be able to facilitate customers' purchases by enabling them to elect a fragrance that best suits their particular tastes. This system should do so in an orderly and systematic fashion leveraging the taxonomic systems already in place. In addition, the system should adapt a time-honored tradition of baseball cards in order to exploit celebrity-branded fragrances.

### SUMMARY OF THE INVENTION

It is an object of the present invention to provide for a more orderly and precise fashion to market fragrances through cards which are similar to baseball cards. On each card there may be an image of a celebrity or athlete with their favorite fragrance. Each card may be imbued with that particular fragrance. In addition, the card may contain further information about closely related fragrances, which may be of interest to the customer.

It is an object of the present invention to enable the customization of fragrances by presenting consumers with similar alternatives which are related by chemistry and through various taxonomic systems. These alternatives can also be made based on other factors such as price, lifestyle, trends, etc.

### BRIEF DESCRIPTION OF THE DRAWING FIGURES

FIG. 1 is a plan view of a preferred embodiment of the present invention.

FIG. 2 is a plan view of a preferred embodiment of the present invention.

FIG. 3 is a plan view of a preferred embodiment of the present invention.

FIG. 4 is a side elevation view of a preferred embodiment of the present invention.

FIG. 5 is a plan view of a preferred embodiment of the present invention.

FIG. 6 is a perspective view of a preferred embodiment of the present invention.

FIG. 7 is a front view of a preferred embodiment of the present invention.

FIG. 8 is a plan view of a preferred embodiment of the present invention.

FIG. 9 is a plan view of a preferred embodiment of the present invention.

### DESCRIPTION OF PREFERRED EMBODIMENTS

According to a preferred embodiment of the present invention, a unique Fragrance Sampling, and Exhibition System is used for the purpose of marketing fragrances in a more orderly, and systematic way. The present invention is described in enabling detail below.

It should be noted here that the present invention incorporates by reference a previous pending patent application (hereafter “fragrance system patent” by the same applicant/inventor entitled “A Fragrance Inventory and Display System for Cataloguing, Storing, Categorizing, Sampling, Exhibiting, and Ordering various Fragrances”.

For the purpose of the present invention the term “Fragrance” shall be defined as an aroma compound, also known as odorant, aroma, fragrance or flavor, is a chemical compound that has a smell or odor. It should be noted here that the scope of the present invention is not meant to be construed to be limiting to only fragrances such as perfumes or colognes. Other scents, smells, or other substances producing various olfactory smells may be used with the present invention as well. For the aforementioned reasons, the terms “scents” and “fragrances” shall be used interchangeably.

For the purposes of the present invention, various taxonomical fragrance terms used in the industry such as “Fresh Notes” are used to describe various fragrances which exhibit signature smells which are inherent and characteristic of all or most member fragrances of that family.

It is understood that the study and the taxonomy of fragrances is fluid and is constantly being changed. As such, one skilled in the art should appreciate the fact that various terms describing classes or families of fragrances are not meant to be construed as limiting to the scope of the present invention. Rather, it is the use of systematic use of these fragrances, and their constituent components whereby specific notes, or other discernible characteristics can be used to accurately research various fragrances, odors, or other smells.

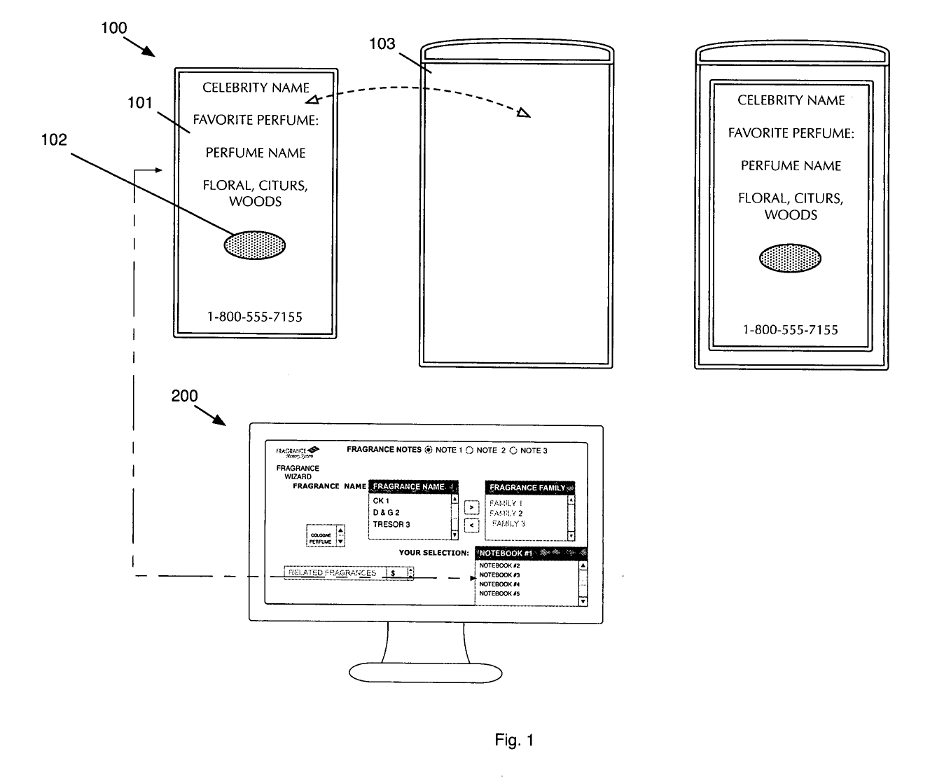

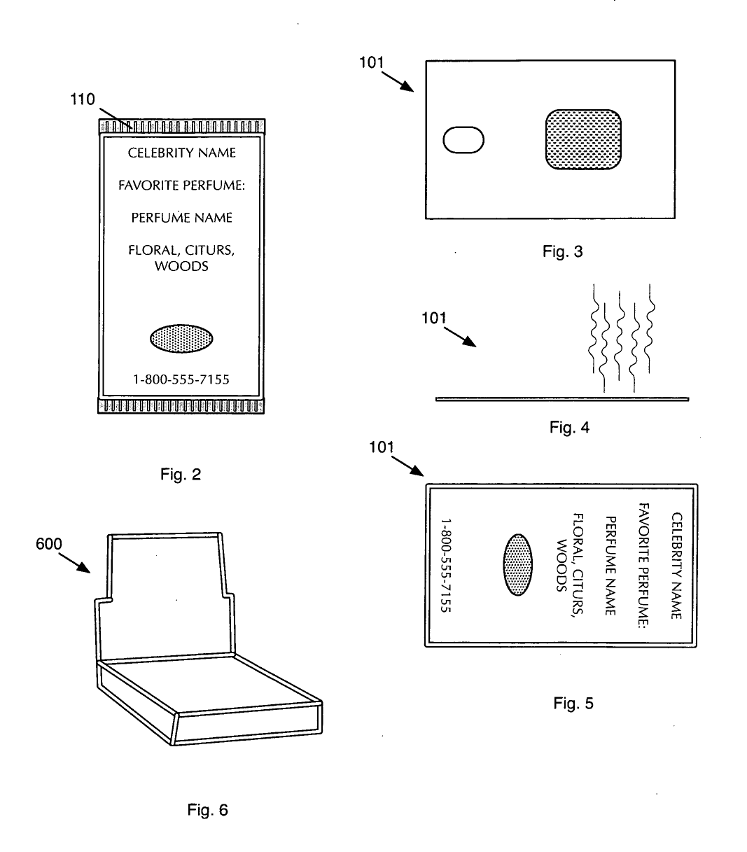

FIG. 1 illustrates a preferred embodiment of the present invention. A Fragrance Sampling, and Exhibition System 100 includes a fragrance card 101, fragrance 102, and a laminated envelope 103. The fragrance 102 is disposed upon the fragrance card. The fragrance card 101 is disposed within the laminated envelope 103. The Fragrance Sampling, and Exhibition System 100 is used in conjunction with the previous patent, hereinafter referred to as Database System 200.

In some preferred embodiments, the fragrance cards may be packaged together in a hermetically sealed wrapper 110. In other preferred. embodiments, they may be packaged in other methods.

In operation, the fragrance card may have a person's image imprinted onto one side of the fragrance card labeled indicia 105. On the opposite side of the fragrance card, the fragrance is disposed thereto.

Moreover, these fragrance cards may be similar in likeness to baseball, basketball, or football cards. However, in the present case, the cards may exhibit celebrities who may not necessarily be a professional athlete. Information may include various biographical information as well as their own endorsed fragrances.

FIG. 9 illustrates that through incorporating the previous fragrance system patent, the card 101 may contain information regarding closely related fragrances. For instance, if celebrity X prefers fragrances A, B, and C, the reverse side of the card 101 may further include similar fragrances to A, B, and C. These analogues 501 may also be included in the pack with their own fragrances and indicia. These analogues 501 may closely approximate fragrances A, B, and C as per the fragrance system patent. Through this method, a prospective customer may be able to choose a perfume better suited to their particular aesthetic tastes.

In addition, prospective customers may be able to use the present invention to procure fragrances which may be a better fit for their particular budget. For instance, if Celebrity X prefers “Choice 1” fragrance, the Card 101 may include information on similarly related fragrances which may be generic versions of “Choice 1” fragrance. Alternatively, the card may list less expensive versions of the same fragrance, but may diverge from “Choice 1” fragrance slightly.

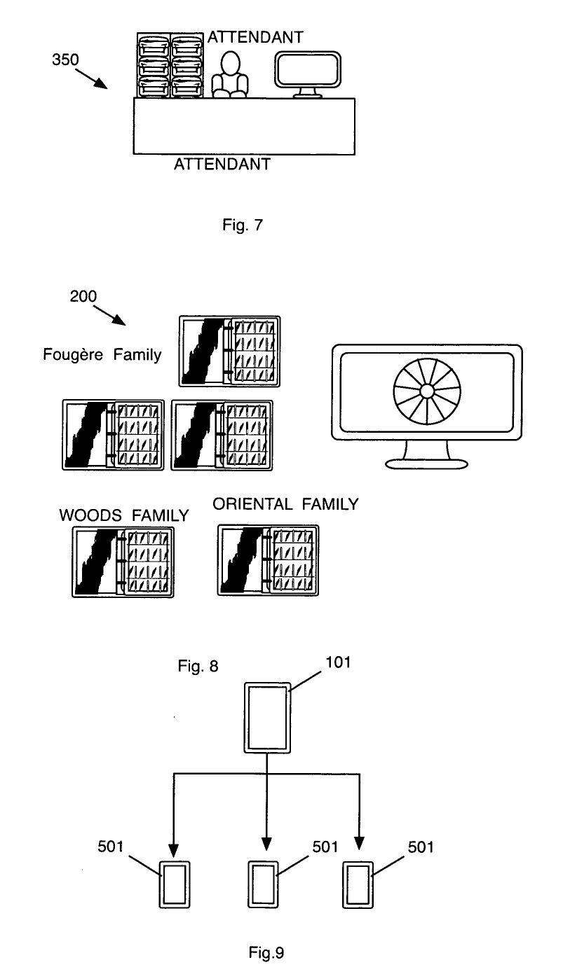

In terms of marketing, the present invention can be leveraged in a plurality of methods. In some cases, the cards can be sold as a point of sale display 600 in retail stores as illustrated in FIG. 7. In other cases, the cards may be disseminated through magazines, and other mail order literature. FIG. 7 illustrates that the cards may be distributed through fragrance and perfume retail centers 350 for customers to take home. Once at home, customers can compare different fragrances and choose the appropriate fragrance at a later date.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Fragrance Sampling, and Exhibition System comprising:
at least one fragrance card, fragrance, and a laminated envelope; the fragrance is disposed upon the fragrance card; the fragrance card is disposed within the laminated envelope.

2. The Fragrance Sampling, and Exhibition System of claim 1 further comprising a computer program, stored on a computer readable medium and executable by a computer system;
the computer program comprises functions for the purpose of cross-indexing fragrances and for storing information about said fragrances.

3. The Fragrance Sampling, and Exhibition System of claim 1 further comprising an interactive display screen for the purpose of enabling a user to research various fragrances.

4. The Fragrance Sampling, and Exhibition System of claim 3 wherein the interactive display screen is a touch-screen monitor in communication with a computer.

5. The Fragrance Sampling, and Exhibition System of claim 1 further comprising at least one Notebook for the purpose of storing a plurality of laminated sheets and the scent strips disposed within the laminated sheets.

6. The Fragrance Sampling, and Exhibition System of claim 1 wherein the computer program further comprises a Wizard Program;
the Wizard Program is comprised of the following steps:
I. requesting the name, family, or type of fragrance a viewer is interested in or requesting a series of questions about the viewer;
II. receiving an answer to the question;
III. displaying results most closely approximating viewer's answers or the parameters thereof.

7. The Fragrance Sampling, and Exhibition System of claim 6 further comprising the step of suggesting a plurality of similar fragrances related to the viewer's request.

8. The Fragrance Sampling, and Exhibition System of claim 5 wherein one claim 5 wherein one Notebook contains scents selected from a family of Woods Notes.

9. The Fragrance Sampling, and Exhibition System of claim 5 wherein one Notebook contains scents selected from a family of Oriental Notes.

10. The Fragrance Sampling, and Exhibition System of claim 5 wherein one Notebook contains scents selected from a family of Fresh Notes.
